(19) United States
(12) Patent Application Publication
(10) Pub. No.: US 2023/0243930 A1
(43) Pub. Date: Aug. 3, 2023

(54) LIDAR ASSEMBLY

(71) Applicant: Robert Bosch GmbH, Stuttgart (DE)

(72) Inventor: Mustafa Kamil, Ludwigsburg (DE)

(21) Appl. No.: 18/003,550

(22) PCT Filed: Jun. 29, 2021
(86) PCT No.: PCT/EP2021/067863

§ 371 Date: Jan. 26, 2023

(30) Foreign Application Priority Data
Jun. 30, 2020 (DE) 10 2020 208 127.1

(51) Int. Cl. G01S 7/481; G01S 17/931

(52) U.S. Cl. CPC G01S 7/4817; G01S 17/931

(57) ABSTRACT

A lidar assembly. The lidar assembly includes a rotor, which is situated so as to rotate about an axis of rotation. The rotor has at least two sensor devices. Each sensor device has at least one laser and detector pair. Each sensor device is designed to acquire a separate sensor range of a gapless field of view area situated parallel to the axis of rotation. The sensor devices are disposed in different circumferential positions of the rotor.

### FIELD

The present invention relates to a lidar assembly. More specifically, the present invention relates to a lidar assembly having a compact design.

### BACKGROUND INFORMATION

Lidar assemblies are used for an environment detection in motor vehicles. A lidar assembly includes a laser and a receiver unit, which are usually situated on a rotation element. Frequently, multiple lasers and receiver units are stacked on top of one another, which often requires a large space for the lidar assembly.

### SUMMARY

The lidar assembly according to the present invention may offer the advantage of a very simple and cost-effective assembly that offers a particularly compact design. According to an example embodiment of the present invention, this may be achieved by a lidar assembly which includes a rotor having at least two sensor devices. The rotor is disposed so as to rotate about an axis of rotation. Each sensor device has at least one laser and detector pair. Each sensor device is designed to acquire a separate sensor range of a gapless field of view are situated parallel to the axis of rotation. The sensor devices are disposed at different circumferential positions of the rotor.

In other words, the rotor includes at least two sensor devices, which cover an exclusive portion of the field of view area of the lidar assembly in each case. The sensor devices are positioned in such a way that they are disposed distributed across the circumference of the rotor. A height of the rotor in the direction of the axis of rotation is able to be kept especially compact in this way. This is particularly achieved in that electronic and mechanical components of the sensor devices as parts of the laser and detector pairs, e.g., electrical lines, control devices, housings or the like, are able to be distributed across a volume of the rotor in such a way that an optimal utilization of the space is possible.

According to an example embodiment of the present invention, the axis of rotation preferably extends in a vertical direction so that the lidar assembly is designed to use the sensor devices for scanning a horizontal field of view by a rotation of the rotor. The field of view area parallel to the axis of rotation corresponds to a vertical field of view of the lidar assembly, which is regionally acquired and without gaps in the vertical direction, by a corresponding alignment of the sensor devices. In other words, the sensor devices are positioned and aligned in such a way that the particular sensor ranges directly abut one another in the vertical direction, but particularly do not overlap. This ensures a gapless and efficient acquisition of the vertical field of view area.

In the process, the positioning of the sensor devices distributed in the circumferential position on the rotor causes the separate sensor ranges to be scanned at different points in time. This results in further advantages in connection with a detection of the environment with the aid of the lidar assembly. Since the respective information recorded by the sensor devices was supplied at different points in time during precisely one rotation of the rotor, a more even distribution of a data transfer of measured data takes place from and/or to the lidar assembly. In other words, a data transmission channel is loaded more evenly during a full rotation of the rotor. In the case of large objects to be detected that extend in particular across multiple sensor ranges, for example, an optimized time resolution in the acquisition is possible in addition. This means, a dark phase, i.e., a time period during which none of the sensor devices is able to view an environment but is situated inside a housing, for instance, is very short in the case of such large objects so that a particularly reliable and temporally highly resolved acquisition is able to be carried out.

In addition, according to an example embodiment of the present invention, the distribution of the sensor devices across the circumference of the rotor allows for a more even thermal loading of the rotor. While the lidar assembly is in operation, heating of the sensor devices may occur. Because the sensor devices are situated at different locations of the rotor, no hotspots arise by heat sources that are situated close to one another. An optimal heat distribution and, preferably, an improved heat dissipation are therefore possible while the lidar assembly is in operation.

Preferred refinements of the present invention are disclosed herein.

According to an example embodiment of the present invention, the sensor devices are preferably situated at an offset in an axial direction. This particularly means without an overlap. In other words, the sensor devices are preferably situated in different axial planes, which especially are perpendicular to the axis of rotation. This makes it possible to provide an especially simple and cost-effective construction of the lidar device because the axial offset of the sensor devices preferably allows for a simple implementation of the separation of the sensor ranges.

It is especially preferred that the sensor ranges extend in the direction of a scanning direction in each case, all scanning directions of the sensor devices being parallel to one another. The scanning direction preferably represents an axis of symmetry of the respective sensor range. For example, the sensor range may be an angular range which is restricted by two boundary lines that are situated at an acute angle, in particular of 4° to 12°, preferably 8°, relative to one another. As an alternative, the sensor range may be restricted by two parallel boundary lines, which are situated at a predefined distance from the scanning direction in each case. As a result, the sensor devices may be identically aligned in the different axial planes, so that a particularly simple and cost-effective construction of the lidar assembly can be achieved.

According to an example embodiment of the present invention, all sensor devices are preferably situated in the same axial region of the rotor. This particularly means that the sensor devices overlap along the direction of the axis of rotation. This makes it possible to achieve an especially low height of the rotor. Because of the offset positioning along the circumference, sufficient space is provided for the sensor devices and the components connected thereto.

Especially preferably, according to an example embodiment of the present invention, the center points of all sensor devices are situated in a common plane perpendicular to the axis of rotation. Each center point preferably corresponds to a center of mass of the respective sensor device. This means that all sensor devices are situated at the same axial height on the rotor. An especially compact design of the rotor and also a particularly even mass distribution for a rotation without any imbalance are able to be achieved in this way.

According to an example embodiment of the present invention, it is furthermore preferred if each sensor range extends along a scanning direction, the scanning directions being inclined at a predefined angle to one another. In other words, to cover the required field of view area, each scanning direction is inclined in such a way that the vertical field of view is able to be scanned in an optimal manner. The angle is preferably selected such that the sensor ranges cover the field of view area without gaps and in its entirety at a predefined distance from the axis of rotation. For example, the sensor ranges may overlap at a shorter distance and gaps may exist between the sensor ranges at a greater distance, for instance.

The angle preferably amounts to at least 4°, preferably to maximally 12°, and most preferably to 8°. This makes it possible to provide a positioning and alignment of the sensor devices that is optimally adapted to construction-related field of view areas of the sensor devices and to distances to be detected, for instance.

According to an example embodiment of the present invention, the rotor preferably has a mounting surface for each sensor device, which is designed for the fastening of the respective sensor device. The mounting surface is situated perpendicular to the corresponding scanning direction of the sensor device. In other words, the mounting surfaces of the rotor form corresponding reference surfaces for the accommodation of the sensor devices.

The mounting surfaces are situated in such a way that the desired alignment of the sensor devices is able to be ensured in a simple and cost-effective manner. This avoids a complex retroactive alignment of the sensor devices after the mounting, and the correct orientation can already be ensured when the sensor devices are mounted on the rotor. For example, the rotor may be developed as a milled component for this purpose. This allows for a particularly cost-effective production and at the same time ensures a high precision of the alignment.

Especially preferably, the sensor devices can be fixed in place on the rotor with the aid of a screw connection and/or a snap-in connection. This allows for a particularly simple, rapid and economical assembly of the lidar assembly. Through a corresponding alignment of the mounting surfaces provided for the mounting, the desired alignment of the sensor devices is able to be achieved in a simple and precise manner.

The sensor devices are preferably distributed evenly across the circumference of the rotor. This means that the sensor devices are disposed at the same distances from one another with regard to the circumferential direction. In addition to a uniform acquisition of the environment by images of the sensor devices that were recorded at evenly spaced time intervals, this even positioning also offers the advantage of avoiding an imbalance during the rotation of the rotor. The even distribution of the sensor devices about the circumference of the rotor preferably additionally allows the rotor to be developed in a point-symmetric manner with respect to the axis of rotation. This results in an especially advantageous, even mass distribution of the rotor and therefore ensures an even rotation of the rotor.

According to an example embodiment of the present invention, each sensor device preferably has a multitude of laser and detector pairs. The laser and detector pairs are situated next to one another in a direction parallel to the axis of rotation. One laser and one detector of each laser and detector pair is preferably situated in a shared plane that lies perpendicular to the axis of rotation.

According to an example embodiment of the present invention, each laser and detector pair is preferably designed to acquire a separate detector region of the sensor range. That means that the sensor range is preferably subdivided into a number of detector regions that corresponds to the number of laser and detector pairs disposed next to one another in a direction parallel to the axis of rotation, each laser and detector covering precisely one detector region. Each detector region preferably covers an angular range of 0.15° of the vertical field of view. Given a total vertical field of view of preferably 24° and a total of three sensor devices, each covering an angular range of 8°, 53 laser and detector pairs per sensor device are preferably provided.

Especially preferably, according to an example embodiment of the present invention, the lidar assembly also includes a stator having an optics system. The rotor is preferably disposed so as to allow it to rotate relative to the stator. The rotor is particularly at least partially accommodated within the stator. The optics system may preferably have a lens. More specifically, the optics system is set up to bundle and/or expand and/or deflect light beams emitted and/or received by the sensor device. The optics system preferably includes a shared optics unit, which is situated in a beam path of all sensor devices, for example.

According to an example embodiment of the present invention, it is furthermore preferred that the optics system has a separate optics unit for each sensor device. Especially in the case of sensor devices situated at an offset in the axial direction, the optics units may be positioned next to one another in the stator and in a direction parallel to the axis of rotation so that a beam path of each sensor device preferably runs through a separate optics unit.

### BRIEF DESCRIPTION OF THE DRAWINGS

Below, exemplary embodiments of the present invention are described in detail with reference to the figures. Identical or functionally equivalent components have always been provided with the same reference numerals in the drawings.

FIG. 1 shows a simplified schematic view of a lidar assembly according to a first exemplary embodiment of the present invention.

FIG. 2 shows a simplified schematic view of a lidar assembly according to a second exemplary embodiment of the present invention.

FIG. 3 shows a simplified schematic view of a lidar assembly according to a third exemplary embodiment of the present invention.

### DETAILED DESCRIPTION OF EXAMPLE EMBODIMENTS

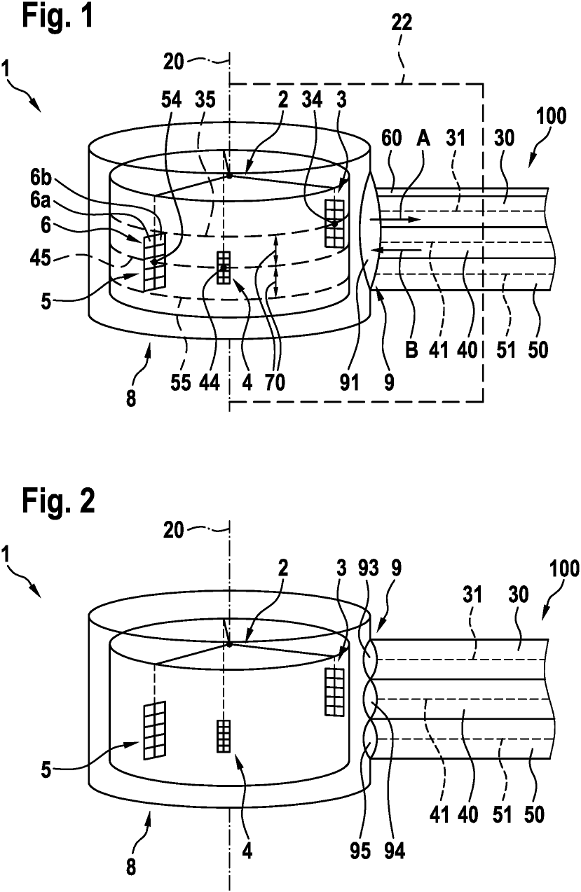

FIG. 1 shows a greatly simplified schematic view of a lidar assembly 1 according to a first exemplary embodiment of the present invention. Lidar assembly 1 includes a rotor 2, which is positioned so as to rotate about an axis of rotation 20. Axis of rotation 20 is vertically positioned.

Rotor 2 has three sensor devices 3, 4, 5. Each sensor device 3, 4, 5 includes a multitude of laser and detector pairs 6. Each laser and detector pair 6 is made up of a laser 6a and a detector 6b, which are situated next to each other in a plane running perpendicular to axis of rotation 20. Each laser 6a is set up to emit a laser beam. A backscattered component of the laser beam, e.g., by a reflection at an object in an environment of laser assembly 1, is able to be received by detector 6b. Laser and detector pairs 6 of each sensor device 3, 4, 5 are positioned along a direction running parallel to axis of rotation 20.

Sensor devices 3, 4, 5 are situated at different circumferential positions of rotor 2. In detail, sensor devices 3, 4, 5 are disposed evenly distributed about the circumference of rotor 2.

In addition, sensor devices 3, 4, 5 are situated at an offset in an axial direction. That means that each one of sensor devices 3, 4, 5 is situated at a different axial height of rotor 2. Sensor devices 3, 4, 5 are positioned so that they directly abut one another when viewed perpendicular to axis of rotation 20, but they especially do not overlap.

Center points 34, 44, 54 of sensor devices 3, 4, 5 sit on separate circumferential lines 35, 45, 55 of rotor 2, the circumferential lines 35, 45, 55 being disposed at a predefined axial distance 70 from one another. Center points 34, 44, 54 of sensor devices 3, 4, 5 correspond to centers of mass of sensor devices 3, 4, 5 in each case.

Rotor 2 is situated within a housing, which forms a stator 8 of lidar assembly 1. Stator 8 includes an optics system 9 having a single optics unit 91, which, for instance, includes a lens for selectively directing the laser beams toward the environment.

To scan the environment of lidar assembly 1, the laser beams emitted by sensor devices 3, 4, 5 are emitted through optics unit 91. In the process, a horizontal field of view area and a vertical field of view area 100 are scanned in each case.

The acquisition of vertical field of view area 100, which lies in a plane 22 in which axis of rotation 20 is situated in the snapshot shown in FIG. 1, is realized by the corresponding positioning of sensor devices 3, 4, 5 along the different axial positions on rotor 2. Each sensor device 3, 4, 5 is set up to acquire a separate sensor range 30, 40, 50 of the vertical field of view area 100. Sensor ranges 30, 40, 50 directly abut one another so that gapless scanning of vertical field of view area 100 is possible.

Each sensor range 30, 40, 50 extends along a scanning direction 31, 41, 51. Scanning directions 31, 41, 51 of all sensor devices 3, 4, 5 are parallel to one another to enable a particularly simple positioning of sensor devices 3, 4, 5, with the same orientation in each case, at the circumference of rotor 2.

In addition, each sensor range 30, 40, 50 is able to be subdivided into a number of detector regions 60 that corresponds to the number of laser and detector pairs 6 per sensor device 3, 4, 5, exemplarily shown by a single detector range 60. Each laser and detector pair 6 is designed to acquire a separate detector range 60. In other words, vertical field of view area 100 is covered by the vertical staggering of sensor devices 3, 4, 5, which in turn are staggered in the form of multiple laser and detector pairs 6.

The scanning of the horizontal field of view area is implemented by the rotation about axis of rotation 20. During precisely one full rotation of rotor 2, an acquisition of measuring data takes place at three evenly spaced points in time due to the positioning of sensor devices 3, 4, 5 distributed around the circumference.

The special positioning of sensor devices 3, 4, 5 distributed around the circumference of rotor 2 and staggered in an axial direction offers multiple advantages with regard to the construction and operation of lidar assembly 1. Because of the even distribution around the circumference of rotor 2, sensor devices 3, 4, 5 are arranged at a maximum distance from one another so that an optimal distribution of the space of rotor 2 is possible. More specifically, this may avoid that components allocated to sensor devices 3, 4, 5 such as wiring or the like require additional space in an effort to avoid overlaps or similar problems. Rotor 2 can thus have a particularly compact design with an especially low axial height.

In addition, the even distribution around the circumference allows for an even mass distribution on rotor 2 so that imbalances during the rotation can be avoided.

Moreover, the acquisition of the measured data distributed across an entire rotation of rotor 2 offers the advantage of even loading of a data transmission channel from sensor device 3, 4, 5 to a central control device, for example.

In addition, an optimized acquisition, e.g., of large objects in the environment that extend across multiple sensor ranges 30, 40, 50, is achieved because measured data for detecting a distance of the object, for example, are correspondingly acquired at multiple points in time during a rotation of rotor 2.

FIG. 2 shows a greatly simplified schematic view of a lidar assembly 1 according to a second exemplary embodiment of the present invention. The second exemplary embodiment essentially corresponds to the first exemplary embodiment of FIG. 1, except for an alternative development of optics system 9. In the second exemplary embodiment, optics system 9 has a separate optics unit 93, 94, 95 for each sensor device 3, 4, 5. Optics units 93, 94, 95 are situated next to one another according to the vertical positioning of sensor ranges 30, 40, 50 in the vertical direction, that is, along axis of rotation 20.

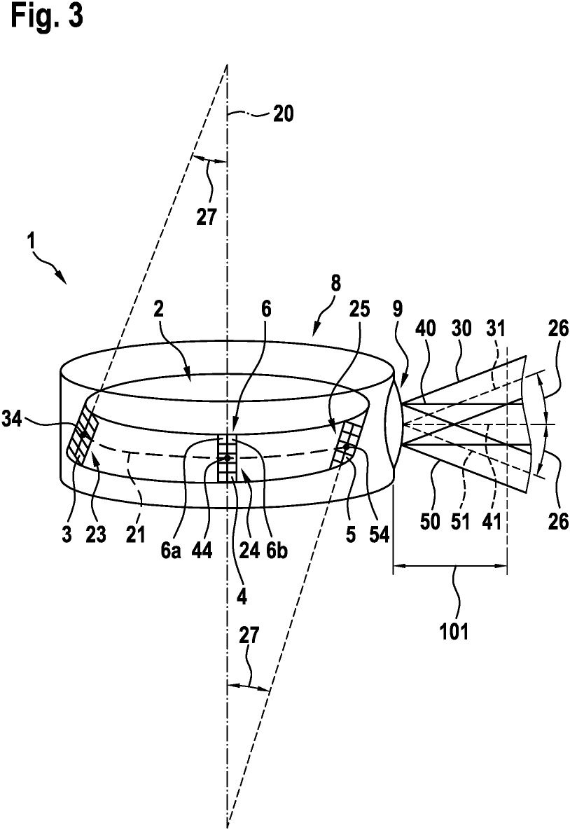

FIG. 3 shows a greatly simplified schematic view of a lidar assembly 1 according to a third exemplary embodiment of the present invention. The third exemplary embodiment essentially corresponds to the first exemplary embodiment of FIG. 1, with an alternative development of rotor 2 and an alternative positioning of sensor devices 3, 4, 5 on rotor 2. In the third exemplary embodiment, sensor devices 3, 4, 5 are disposed at the same axial height. In detail, center points 34, 44, 54 lie in a common plane 21 perpendicular to axis of rotation 20. This makes it possible to provide a particularly compact construction of lidar assembly 1 because rotor 2 is able to be embodied with an especially low vertical height.

To cover vertical field of view area 100, sensor devices 3, 4, 5 are inclined relative to one another and thus inclined at different angles with regard to axis of rotation 20.

First sensor device 3 is inclined to axis of rotation 20 at an angle 27 so that first scanning direction 31 has an upward inclination to the horizontal at an angle 26 which corresponds to angle 27. Second sensor device 4 is disposed parallel to axis of rotation 20 so that corresponding second scanning direction 41 is parallel to the horizontal. In addition, third sensor device 5 is inclined at an angle 27 in the opposite direction compared to first sensor device 3, with respect to axis of rotation 20. Third scanning direction 51 therefore has a downward inclination at a corresponding angle 26 with respect to the horizontal.

Angles 26 and 27 are configured in such a way that sensor ranges 30, 40, 50 especially do not overlap at a predefined distance 101 from optics system 9. In other words, at distance 101 from optics system 9, vertical field of view area 100 is acquired without gaps and without any overlaps of sensor ranges 30, 40, 50. Optics system 9 is preferably set up to provide an optimal resolution precisely at distance 101.

To allow for a simple mounting, rotor 2 has a mounting surface 23, 24, 25 for each sensor device 3, 4, 5, which is situated at a corresponding angle 27 relative to the vertical. Sensor devices 3, 4, 5 are able to be mounted in a simple and cost-effective manner on mounting surfaces 23, 24, 25 on rotor 2 with the aid of a screwed connection and/or with the aid of a snap-in connection, during which the desired orientation of sensor devices 3, 4, 5 is directly achieved by the proper alignment of mounting surfaces 23, 24, 25.

It should be noted that, simply for reasons of better clarity, first sensor device 3 and third sensor device 5 are situated in opposite positions of rotor 2 in FIG. 3. It is particularly advantageous if sensor devices 3, 4, 5 are evenly distributed around the circumference of rotor 2, as in the first and second exemplary embodiments of FIGS. 1 and 2, that is, center points 34, 44, 54 are situated at the circumference of rotor 2 in plane 21 in rotational symmetry with axis of rotation 20.

1–4. (canceled)

15. A lidar assembly, comprising:
a rotor situated so as to rotate about an axis of rotation, the rotor having at least two sensor devices, each of the sensor devices having at least one laser and detector pair, and each of the sensor devices being configured to acquire a separate sensor range of a gapless field of view area situated parallel to the axis of rotation, and the sensor devices being disposed at different circumferential positions of the rotor.

16. The lidar assembly as recited in claim 15, wherein the sensor devices are situated at an offset in an axial direction.

17. The lidar assembly as recited in claim 16, wherein each of the sensor ranges extends along a scanning direction, and the scanning directions being parallel to one another.

18. The lidar assembly as recited in claim 15, wherein all of the sensor devices are situated in the same axial region of the rotor.

19. The lidar assembly as recited in claim 18, wherein center points of all sensor devices are situated in a common plane perpendicular to the axis of rotation.

20. The lidar assembly as recited in claim 18, wherein each of the sensor ranges extends along a scanning direction, and the scanning directions are inclined at a predefined angle to one another.

21. The lidar assembly as recited in claim 20, wherein the angle is at least 4° to maximally 12°.

22. The lidar assembly as recited in claim 20, wherein the angle is at least 4° to maximally to 8°.

23. The lidar assembly as recited in claim 20, wherein the rotor has a mounting surface for each sensor device of the sensor devices for fastening the sensor devices, and the mounting surface is situated perpendicular to the corresponding scanning direction of the sensor device.

24. The lidar assembly as recited in claim 15, wherein the sensor devices are fastened on the rotor using a screw connection and/or with the aid of a snap-in connection.

25. The lidar assembly as recited in claim 15, wherein the sensor devices are evenly distributed about a circumference of the rotor.

26. The lidar assembly as recited in claim 15, wherein each sensor device has a multitude of laser and detector pairs, which are situated next to one another in a direction parallel to the axis of rotation.

27. The lidar assembly as recited in claim 26, wherein each laser and detector pair is configured to acquire a separate detector region of the sensor range.

28. The lidar assembly as recited in claim 15, further comprising:
a stator having an optics system.

29. The lidar assembly as recited in claim 28, wherein the optics system has a separate optics unit for each of the sensor devices.
